(19) United States
(12) Patent Application Publication
(10) Pub. No.: US 2004/0202958 A1
(43) Pub. Date: Oct. 14, 2004

(54) Plating-pretreatment solution and plating-pretreatment method

(75) Inventors: Tatsuo Kataoka, Saitama (JP); Yoshikazu Akashi, Saitama (JP)

Correspondence Address: Kent E. Baldauf, 700 Koppers Building, 436 Seventh Avenue, Pittsburgh, PA, 15219-1818, US

(73) Assignee: MITSUI MINING & SMELTING CO., LTD.

(21) Appl. No.: 10/820,994

(22) Filed: Apr. 8, 2004

(30) Foreign Application Priority Data
Apr. 9, 2003 (JP) 2003-105685

(51) Int. Cl. G03C 1/76

(52) U.S. Cl. 430/270.1

(57) ABSTRACT

A plating-pretreatment solution comprising an organic sulfonic acid, thiourea, fluoroboric acid and hypophosphorous acid and a plating-pretreatment method comprising contacting a film carrier tape in which a wiring pattern is formed on a surface of an insulating film with a plating-pretreatment solution comprising an organic sulfonic acid, thiourea, fluoroboric acid and hypophosphorous acid to remove metals remaining on the insulating film. According to the plating-pretreatment solution and the plating-pretreatment method, metals remaining on the surface of the insulating film exposed by etching are removed, and the occurrence of migration is prevented.

### FIELD OF THE INVENTION

The present invention relates to a plating-pretreatment solution and a method using the solution. More particularly, the present invention relates to a solution to remove metals remaining on a surface of an insulating film between wirings of a wiring pattern, said solution being used after formation of the wiring pattern by fine-pitch etching of a base having a metal layer on the insulating film surface and before plating of the wiring pattern, and a method using the solution.

### BACKGROUND OF THE INVENTION

For mounting electronic parts, film carrier tapes have been conventionally employed. The film carrier tapes for mounting electronic parts are produced by a process comprising bonding a conductive metal foil such as a copper foil to a surface of an insulating film such as a polyimide film through an adhesive layer, coating a surface of the conductive metal foil with a photoresist, exposing and developing the photoresist to form a desired pattern, etching the conductive metal foil using the pattern as a masking material to form a wiring pattern composed of the conductive metal foil, coating the wiring pattern with a solder resist except the lead portions of the wiring pattern, and then plating the lead portions exposed from the solder resist layer.

In order to mount the electronic parts more densely, the width of the wiring pattern has become extremely small recently, and in order to form a wiring pattern of a small width, it is necessary to form a thin conductive metal layer correspondingly to the wiring pattern of a small width.

In the prior art, the conductive metal layer has been formed by bonding a conductive metal foil such as an electrodeposited copper foil to the insulating film surface by the use of an adhesive, however, the thickness of the conductive metal foil which can be handled alone is restricted.

Then, a thin-layer base in which a metal is directly deposited on a surface of the insulating film has been employed recently. The thin-layer base is produced by a process comprising providing a sputtering layer of nickel, chromium, etc. on a surface of an insulating film, then sputtering copper on the Ni—Cr sputtering layer when needed, and further depositing copper in a desired thickness (e.g., about 8 μm) on the sputtering layer by means of electroplating.

The surface of the copper layer thus formed is then coated with a photoresist, and the photoresist is exposed and developed to form a desired pattern. Then, using this pattern as a masking material, etching with an etching solution containing cupric chloride, hydrogen peroxide, etc. is performed, whereby a desired wiring pattern can be formed.

On the surface of the insulating film of the thin-layer base, however, nickel, chromium and the like are deposited by sputtering in order to deposit copper thereon, but metals such as nickel and chromium are hardly dissolved in the etching solution for copper. Further, nickel, chromium and copper are alloyed by sputtering and deposited on the surface of the insulating film, so that they are hardly eluted by the use of the etching solution physically. Because of trace amounts of the metals remaining on the insulating film, insulation properties between wirings of the wiring pattern are sometimes lowered with time.

Moreover, when the thickness of the layer containing nickel, chromium, etc. is increased, or when the amount of chromium in the nickel-chromium composition exceeds 20%, or when the amounts of residual metals are increased, there is another problem that insulation resistance between wirings of the wiring pattern is markedly lowered by the application of a voltage in the constant-temperature constant-humidity environment to thereby shorten the time up to occurrence of migration.

If the etching conditions are changed in order to remove trace amounts of metals remaining on the insulating film, over-etching takes place and the resulting wiring pattern becomes thin. That is to say, an etching solution containing cupric chloride and H₂O₂ is used for etching copper, and when etching is carried out for a long period of time using this etching solution, the amounts of residual metals present between wirings can be decreased, but in case of fine pattern etching (e.g., wire width of 30 μm), because of the small wire width, the top width of the pattern becomes not more than 5 μm.

There is a method of removing residual metals by performing soft etching with potassium persulfate (K₂S₂O₈)+sulfuric acid (H₂SO₄) solution prior to plating. However, if a direct-current voltage is continuously applied to a base, in which a wiring pattern has been treated with this method and then subjected to electroless tin plating, under the conditions of constant temperature and constant humidity (e.g., 85° C.×85% RH×DC60V), burning sometimes occurs between wirings of the wiring pattern in about 100 to 200 hours, and besides, Cu dendrite occurs to markedly lower insulation resistance. That is to say, by the use of only the conventional plating-pretreatment solution containing K₂S₂O₈+H₂SO₄ or H₂O₂, nickel and chromium are hardly removed though copper can be etched, and hence, nickel and chromium often remain between wirings.

Further, in case of treatment with a commercially available solution for dissolving nickel, insufficient cleaning causes remaining of the treated substance on the wiring pattern, and a detrimental influence is rather exerted on the insulation properties.

### OBJECT OF THE INVENTION

It is an object of the present invention to provide a plating-pretreatment solution capable of removing copper alloys containing nickel, chromium, etc. from the surface of the insulating film between wirings, said removing being impossible by the use of conventional plating-pretreatment solutions, and capable of producing film carriers which are rarely lowered in the electrical properties even when a voltage is applied under the conditions of constant temperature and constant humidity after tin plating, and to provide a method using the plating-pretreatment solution.

It is another object of the present invention to provide a plating-pretreatment solution capable of inhibiting occurrence of migration of metals such as copper and a method using the plating-pretreatment solution.

### SUMMARY OF THE INVENTION

The plating-pretreatment solution of the present invention comprises an organic sulfonic acid, thiourea, fluoroboric acid and hypophosphorous acid.

The plating-pretreatment method of the present invention comprises contacting a film carrier tape in which a wiring pattern is formed on a surface of an insulating film with a plating-pretreatment solution comprising an organic sulfonic acid, thiourea, fluoroboric acid and hypophosphorous acid to remove metals remaining on the insulating film.

The plating-pretreatment solution of the present invention is capable of not only dissolving and removing nickel and chromium remaining on the insulating film but also removing copper remaining on the insulating film. Moreover, the plating-pretreatment solution does not cause over-etching of the wiring pattern which has been formed by etching.

Accordingly, by the use of the plating-pretreatment solution of the present invention, changes of electrical properties of the wiring pattern formed, such as lowering of electrical resistance due to occurrence of migration, are not brought about.

### BRIEF DESCRIPTION OF THE DRAWINGS

FIG. 1 is a view showing a test piece having anode and cathode alternate layout pattern (hereinafter refer to comb shaped pattern electrodes), which is used to show effects ascribed to the treatment with the plating-pretreatment solution of the present invention.

FIG. 2 is a graph showing examples of changes with time of electrical resistance values of test pieces which have been treated with the plating-pretreatment solution of the present invention.

FIG. 3 is a graph showing examples of changes with time of electrical resistance values of test pieces which have not been treated with a plating-pretreatment solution.

10: anode and cathode alternate layout pattern (comb shaped pattern electrodes)

### DETAILED DESCRIPTION OF THE INVENTION

The plating-pretreatment solution of the present invention and the method using the plating-pretreatment solution are described in detail hereinafter.

The plating-pretreatment solution of the present invention is a solution which is used for treating, prior to plating, a film carrier obtained by a process comprising depositing nickel, chromium, etc. on an insulating film such as a polyimide film by sputtering, then depositing copper by sputtering if necessary, further depositing copper on the resulting metallic sputtering layer by, for example, electroless plating and copper electroplating to obtain a laminate and forming a wiring pattern in the laminate. In such a film carrier, a conductive metal is directly laminated to the insulating film without interposing an adhesive layer.

When a wiring pattern is formed in the base by etching, the unmasked portion of the conductive metal is eluted to expose the insulating film surface, and on the insulating film surface, trace amounts of metals sometimes remain. These residual metals contain, as main components, nickel and chromium initially sputtered, and in many cases, the nickel and the chromium are present as alloys formed together with copper sputtered later. In the formation of a wiring pattern, an etching agent containing cupric chloride and hydrogen peroxide is used, and this etching solution has good etching properties against copper but does not have so high etching properties against nickel and chromium. Especially when nickel and chromium are alloyed with copper, or especially when the alloys are embedded in the insulating film, these alloys are liable to remain. On the other hand, a commercially available nickel-removing agent can remove nickel, but when nickel is alloyed, particularly when a copper alloy is formed, the alloy is hardly removed and remains in a trace amount on the insulating film surface.

The plating-pretreatment solution of the present invention comprises an organic sulfonic acid, thiourea, fluoroboric acid and hypophosphorous acid, and can remove not only nickel and chromium but also copper.

The organic sulfonic acid contained in the plating-pretreatment solution of the present invention is a regenerant of thiourea. That is to say, thiourea contained in the plating-pretreatment solution of the present invention forms a complex together with copper and is thereby consumed. The organic sulfonic acid used in the present invention regenerates this thiourea. Examples of the organic sulfonic acids include phenolsulfonic acid, methanesulfonic acid, ethanesulfonic acid, propanesulfonic acid, 2-propanesulfonic acid, butanesulfonic acid, 2-butanesulfonic acid, pentanesulfonic acid and chloropropanesulfonic acid. These organic sulfonic acids can be used singly or in combination. In the present invention, phenolsulfonic acid and/or methanesulfonic acid is particularly preferably employed.

The organic sulfonic acid is added in an amount of usually 80 to 240 g, preferably 100 to 200 g, based on 1 liter of the plating-pretreatment solution. By the addition of the organic sulfonic acid in this amount, copper remaining on the insulating film surface can be continuously and efficiently eluted.

The thiourea ((NH₂)₂C═S) contained in the plating-pretreatment solution of the present invention is a copper-removing agent, which forms a complex together with copper remaining on the insulating film to thereby remove copper.

The thiourea is added in an amount of usually 80 to 240 g, preferably 100 to 200 g, based on 1 liter of the plating-pretreatment solution. By the addition of thiourea in this amount, copper remaining on the insulating film surface can be efficiently eluted. The thiourea forms a complex together with copper remaining on the insulating film to thereby remove copper remaining on the insulating film as described above, and by virtue of the organic sulfonic acid, thiourea is regenerated from the complex of thiourea and copper.

The fluoroboric acid contained in the plating-pretreatment solution of the present invention serves not only to elute nickel and chromium remaining on the insulating film but also to dissolve copper.

The fluoroboric acid is added in an amount of usually 30 to 100 g, preferably 50 to 80 g, based on 1 liter of the plating-pretreatment solution. The fluroboric acid may be added as it is, or may be added as a salt, such as a potassium salt or a sodium salt. By the addition of the fluoroboric acid in the above amount, metals remaining on the insulating film surface, such as nickel and chromium, can be efficiently eluted, and besides, solubility of copper eluted by thiourea becomes good.

The hypophosphorous acid contained in the plating-pretreatment solution of the present invention is a stabilizer of the plating-pretreatment solution.

The hypophosphorous acid is added in an amount of usually 30 to 100 g, preferably 50 to 80 g, based on 1 liter of the plating-pretreatment solution. The hypophosphorous acid (H₃PO₄) may be added as it is, or may be added as a salt, such as a potassium salt or a sodium salt. By the addition of the hypophosphorous acid in the above amount, the plating-pretreatment solution of the present invention can be stably used for a long period of time.

To the plating-pretreatment solution of the present invention, a surface active agent is preferably added. By the addition of the surface active agent to the plating-pretreatment solution of the present invention, wettability of the film carrier tape (subject to be treated) by the plating-pretreatment solution can be enhanced, and the surface of the film carrier tape can be uniformly treated. As the surface active agent for the present invention, any of a cationic surface active agent, an anionic surface active agent and a nonionic surface active agent is employable. In the present invention, a cationic surface active agent or an anionic surface active agent is preferably employed, and a cationic surface active agent is particularly preferably employed. Examples of the cationic surface active agents include lauryltrimethylammonium chloride and lauryldimethylbenzeneammonium choride. These surface active agents can be used singly or in combination. The lauryltrimethylammonium chloride and the lauryldimethylbenzeneammonium choride are stable in the plating-pretreatment solution of the present invention, and by the use of such surface active agents, treatment efficiency due to the plating-pretreatment solution of the present invention can be enhanced, and besides, the film carrier tape can be uniformly treated with the plating-pretreatment solution.

In the present invention, the surface active agent is added in an amount of usually not less than 10 g, preferably 20 to 100 g, based on 1 liter of the plating-pretreatment solution. By the addition of the surface active agent in this amount, the film carrier tape can be extremely uniformly treated with the plating-pretreatment solution.

In addition to the above components, other components may be added to the plating-pretreatment solution of the present invention within limits not detrimental to the properties of the plating-pretreatment solution of the present invention. Examples of other components, which may be added, include a pH adjustor and an inhibitor.

In the plating-pretreatment solution of the present invention, the components mentioned above are dissolved in an aqueous medium, particularly water.

A pH value of the plating-pretreatment solution of the present invention at 25° C. is usually not more than 1.

By the contact of the plating-pretreatment solution of the present invention with a film carrier tape having a wiring pattern formed therein, metals, such as nickel, chromium and copper, which remain on the insulating film where the wiring pattern is not formed can be removed.

The film carrier tape to be treated with the present invention is a film carrier tape obtained by a process comprising coating a surface of a conductive metal layer of a base film which consists of an insulating film and the conductive metal layer formed on at least one surface of the insulating film without interposing an adhesive layer, with a photoresist, exposing and developing the photoresist to form a desired pattern composed of the photoresist, and selectively etching the conductive metal layer using the pattern as a masking material to form a wiring pattern. This film carrier tape has no adhesive layer, and is formed by the use of a base obtained by depositing metals such as nickel and chromium on the surface of the insulating film by sputtering, then sputtering copper and further depositing a layer of a conductive metal such as copper on these metals by electroplating. The conductive metal layer may be formed on one surface of the insulating film or may be formed on both surfaces of the insulating film. The thickness of the insulating film is in the range of usually 12.5 to 75 μm, preferably 25 to 50 μm, and the thickness of the conductive metal layer is in the range of usually 3 to 18 preferably 5 to 12 μm, so that a fine-pitch wiring pattern having a wire width of not more than 50 μm, preferably not more than 45 μm, can be formed. Examples of such bases include S'PER FLEX base available from Sumitomo Metal Mining Co., Ltd. and MICROLUX base available from DuPont Co.

After the formation of a wiring pattern using the base mentioned above, the resulting film carrier tape is contacted with the plating-pretreatment solution of the present invention, whereby metals remaining on the insulating film (i.e., on the insulating film in the spacing of the wiring pattern) are removed.

In the contact process, the temperature of the plating-pretreatment solution is in the range of usually 30 to 80° C., preferably 40 to 80° C. The time for the contact of the film carrier tape with the plating-pretreatment solution at the above temperature is in the range of usually 2 to 60 seconds, preferably 5 to 60 seconds.

By treating the film carrier tape under the above conditions prior to plating, metals (nickel, chromium, copper and alloys thereof) which remain on the insulting film between wirings after the pattern etching can be removed almost completely. In the present invention, it is preferable that the film carrier tape having been subjected to the above treatment prior to plating is then treated with an acid treatment solution comprising 50 to 150 g/l of K₂S₂O₈, 5 to 20 ml/l of H₂SO₄ and 0 to 3 g/l of Cu at a temperature of 20 to 40° C. for a period of 5 to 20 seconds and then subjected to plating.

The film carrier tape having been treated with the plating-pretreatment solution of the present invention as described above is then rinsed with water. Thereafter, a solder resist layer is formed except the outer lead portions and the inner lead portions, and then the exposed lead portions are subjected to plating. As the plating, tin plating, nickel-gold plating, tin-lead plating, tin-bismuth plating or the like is employable.

By the treatment with the plating-pretreatment solution of the present invention, residual metals on the insulating film are removed. Hence, even if electroless Sn plating is carried out after the treatment, the amounts of metals deposited between wirings are extremely decreased, and there is no fluctuation of electrical resistance between the wirings. For example, when a pattern having a narrow pitch of not more than 50 μm formed by etching is treated with the plating-pretreatment solution of the present invention, the amounts of metals remaining between wirings are smaller as compared with a case where the pattern is treated with a conventional solution. Accordingly, when the film carrier is subjected to electroless tin plating and then measured on the amount of tin on polyimide between wirings, the amount of tin is extremely smaller as compared with a case where the film carrier is treated with a conventional nickel-removing solution. That is to say, by virtue of the plating-pretreatment solution of the present invention, the amounts of the residual metals after etching are decreased, and the amounts of metals replaceable with tin in the electroless tin plating solution are decreased. Hence, the count number of tin detected by Auger analysis is decreased.

Further, even if the surface of the insulating film of the film carrier, which has been treated with the plating-pretreatment solution of the present invention, then subjected to pickling with an acid treatment solution (mixed solution) containing K₂S₂O₈ and H₂SO₄ and then subjected to electroless tin plating, is observed by a scanning electron microscope, deposition of tin on the insulating film is not detected.

In case of a test piece of a film carrier, which has been treated with the plating-pretreatment solution of the present invention, then subjected to tin plating under the usual conditions (e.g., plating solution: tin plating solution for electroless plating, temperature: 70° C., time: 2 minutes 45 seconds) and then subjected to annealing (at 125° C. for 1 hour), the migration resistance is twice or more the migration resistance of a test piece which has been treated with a conventional nickel-dissolving solution. More specifically, in case of a test piece having been treated with a conventional nickel-dissolving solution, the electrical resistance is lowered in about 350 to 550 hours, but in case of a test piece having been treated with the plating-pretreatment solution of the present invention, lowering of electrical resistance is not observed even after the passage of 1000 hours.

The plating-pretreatment solution of the present invention has only to be used after formation of a wiring pattern through etching and before plating, as described above, and the treatment with this plating-pretreatment solution may be carried out after the conventional treatment or may be carried out after pickling with sulfuric acid. For example, it is possible that pickling with an acid treatment solution containing K₂S₂O₈ and H₂SO₄ is performed after etching, then treatment with the plating-pretreatment solution of the present invention is performed, thereafter pickling with an acid treatment solution containing K₂S₂O₈ and H₂SO₄ is performed again, and then electroless tin plating is performed. It is also possible that pickling with 2-4 N sulfuric acid is performed for 10 to 60 seconds after etching, then treatment with the plating-pretreatment solution of the present invention is performed, thereafter pickling with an acid treatment solution containing K₂S₂O₈ and H₂SO₄ is performed, and then electroless tin plating is performed.

The plating-pretreatment solution of the present invention is particularly preferably used in a process comprising performing pickling using 2-4 N sulfuric acid for 10 to 60 seconds after etching, then heating the film carrier at a temperature of 150 to 200° C. for a period of 10 minutes to 3 hours to perform ring closure of ring-opened polyimide produced in the polyimide insulting film, then treating the film carrier with the plating-pretreatment solution of the present invention, performing pickling with an acid treatment solution containing K₂S₂08 and H₂SO₄ and then performing tin plating. By performing treatment with the plating-pretreatment solution of the present invention after ring closure of the ring-opened polyimide that is produced on the surface of the polyimide film (i.e., insulating film) by etching; alkaline cleaning, acid cleaning, etc., as described above, migration resistance of the resulting film carrier tape can be remarkably enhanced.

The plating-pretreatment solution of the present invention may be used in combination with a commercially available nickel-removing agent.

The plating-pretreatment solution of the present invention is used in the production of a film carrier from a base obtained by sputtering a nickel-chromium alloy on an insulating film and then depositing a layer of a conductive metal such as copper, as described above. The plating-pretreatment solution of the present invention, however, can be used not only for a film carrier tape produced from a base film having a conductive metal layer formed without interposing an adhesive layer but also for a base of three-layer structure wherein a conductive metal foil (copper foil) is laminated through an adhesive layer or a base of two-layer structure wherein a polyimide film is cast onto a conductive metal foil (copper foil), whereby metals remaining between wirings can be removed. Thus, by the use of the plating-pretreatment solution of the present invention, metals remaining between wirings can be removed, and hence, migration resistance properties of a fine-pitch pattern can be enhanced.

### EFFECT OF THE INVENTION

By the use of the plating-pretreatment solution of the present invention, metals which remain on the surface of the insulating film after a wiring pattern is formed by etching can be efficiently removed. In particular, the plating-pretreatment solution of the present invention can be favorably used for removing a nickel-chromium alloy and copper alloyed with nickel-chromium which remain between wirings of a wiring pattern formed by the use of a base obtained by sputtering a nickel-chromium alloy on a polyimide film without interposing an adhesive layer and then depositing copper by electroplating.

By the treatment with the plating-pretreatment solution of the present invention in the above manner, metals remaining on the insulating film between wirings can be removed, and hence, even if a voltage is continuously applied to the resulting film carrier for a period of not shorter than 1000 hours under the conditions of constant temperature and constant humidity, lowering of electrical resistance between wirings due to migration hardly takes place. Especially in case of a fine-pitch film carrier having a spacing of wiring pattern of not more than 50 μm, migration resistance properties of the film carrier are markedly lowered by the mere remaining of metals in trace amounts on the insulating film. By the use of the plating-pretreatment solution of the present invention after the wiring pattern is formed by etching in accordance with the conventional method, nickel, chromium and alloys of these metals and copper remaining on the insulating film between wirings can be surely removed.

Accordingly, by the use of the plating-pretreatment solution of the present invention, electrical properties can be stably maintained for a long period of time even in a film carrier having a fine pitch of not more than 50 μm. By the use of the plating-pretreatment solution of the present invention, further, production of a film carrier having a narrower pitch becomes feasible.

### EXAMPLES

The present invention is further described with reference to the following examples, but it should be construed that the present invention is in no way limited to those examples.

### Example 1

A plating-pretreatment solution containing phenolsulfonic acid in a concentration of 160 g/liter-water, thiourea in a concentration of 160 g/liter-water, fluoroboric acid in a concentration of 60 g/liter-water, hypophosphorous acid in a concentration of 60 g/liter-water and a cationic surface active agent (lauryltrimethylammonium chloride) in a concentration of 20 g/liter-water was prepared. A pH value of the plating-pretreatment solution at 25° C. was not more than 1.

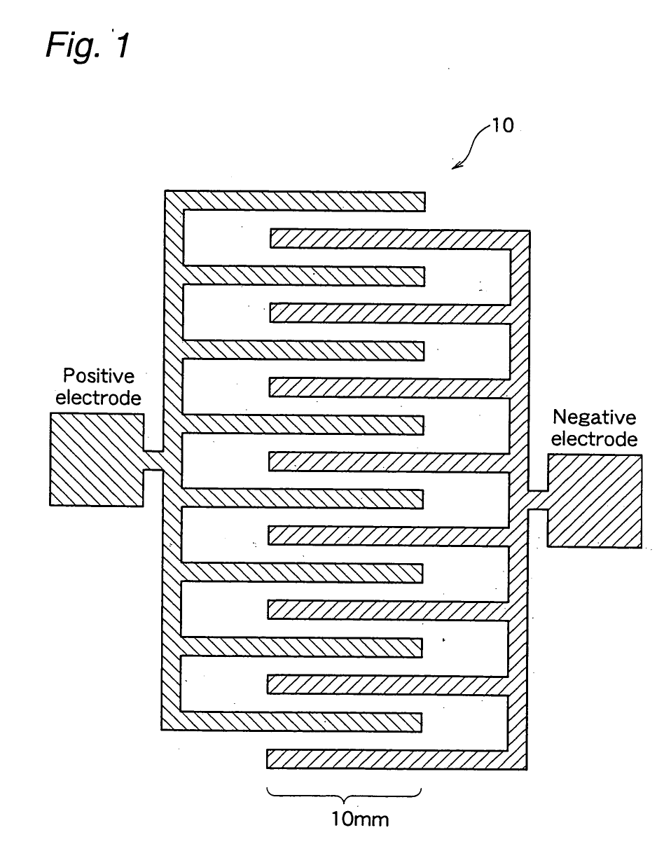

S'PER FLEX (trade name, available from Sumitomo Metal Mining Co., Ltd.), which had been obtained by sputtering a Ni—Cr alloy layer consisting of 7% by weight of Cr and 93% by weight of Ni in a thickness of 70 Å, then plating the layer with Cu by electroless plating and then further plating it with Cu by electroplating in a thickness of 8 μm, was coated with a photoresist, and then the photoresist was subjected to exposure and alkali development. Then, using a cupric chloride solution, comb shaped pattern electrodes of 50 μm pitch were formed by etching as shown in FIG. 1 to prepare three test pieces. The opposite teeth length of the comb shaped pattern electrodes 10 was 10 mm. The positive electrode had 8 teeth, and the negative electrode had 8 teeth.

After the etching, the test pieces having the comb shaped pattern electrodes were immersed in the above-prepared plating-pretreatment solution heated at 70° C., for 30 seconds. The test pieces were rinsed with water and then treated with an acid treatment solution containing K₂S₂O₈ and H₂SO₄ at 30° C. for 10 seconds. The test pieces were then plated by the use of a commercially available electroless plating solution (trade name: LT-34, available from SHIPLEY FAR EAST LTD.) at 70° C. for 2 minutes 45 seconds, then rinsed with water, rinsed with hot water and annealed at 125° C. for 1 hour.

The 50 μm pitch comb shaped pattern electrodes were placed in a constant-temperature constant-humidity bath of 85° C. and 85% RH, and a voltage of DC60 V was applied between the electrodes to measure an insulation resistance.

As a result, even after the passage of 1000 hours, lowering of insulation resistance was not observed in the three test pieces.

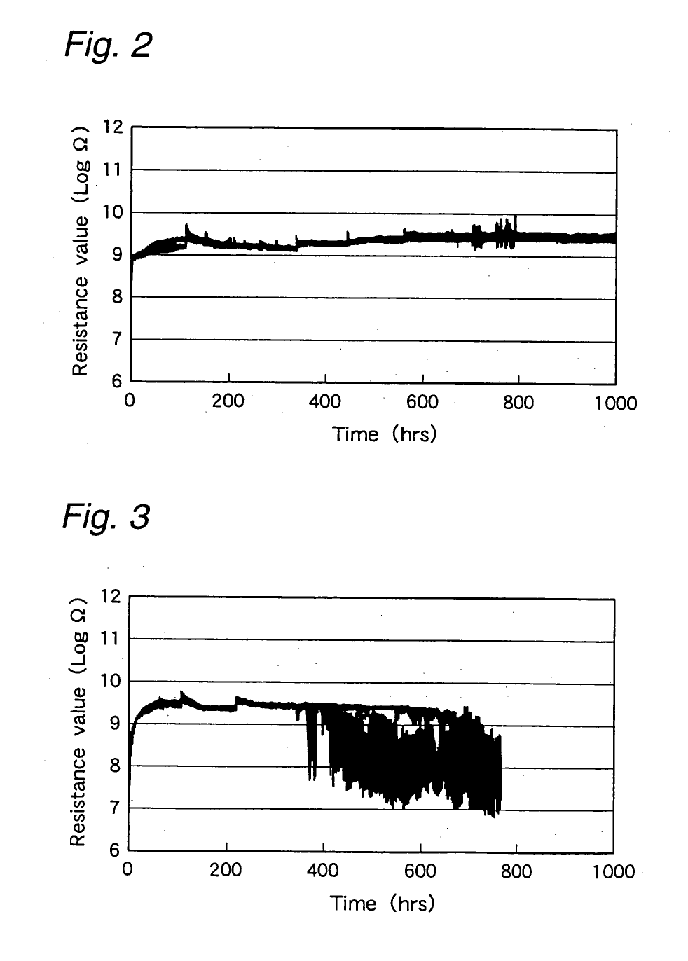

Changes with time of the electrical resistance values of the test pieces having been treated with the plating-pretreatment solution of the present invention are shown in FIG. 2.

### Comparative Example 1

Test pieces were prepared in the same manner as in Example 1, except that the plating-pretreatment solution was not used.

The resulting three test pieces were measured on the electrical resistance in the same manner as in Example 1. As a result, the insulation resistance of the test piece was lowered after the passage of 550 hours, 366 hours or 410 hours.

Changes with time of the electrical resistance values of the test pieces which have not been subjected to the plating-pretreatment are shown in FIG. 3.

### Example 2

Test pieces were prepared in the same manner as in Example 1, except that the pitch of the comb shaped pattern electrodes was changed to 30 μm.

The resulting three test pieces were measured on the electrical resistance in the same manner as in Example 1. As a result, even after the passage of 1000 hours, lowering of insulation resistance was not observed in the three test pieces.

### Comparative Example 2

Test pieces were prepared in the same manner as in Example 2, except that the plating-pretreatment solution was not used.

The resulting three test pieces were measured on the electrical resistance in the same manner as in Example 1. As a result, the insulation resistance of the test piece was lowered after the passage of 266 hours, 324 hours or 376 hours.

It is clear from the comparison of the examples with the comparative examples that by virtue of the treatment with the plating-pretreatment solution of the present invention, lowering of electrical resistance due to occurrence of migration was not observed even after the passage of 1000 hours, while in case of the test pieces which had not been subjected to such a treatment, lowering of electrical resistance due to occurrence of migration was observed during a period of shorter than 1000 hours, specifically 300 to 600 hours in the above experiments. By the use of the plating-pretreatment solution of the present invention, lowering of electrical resistance was observed neither in the wiring pattern of 50 μm pitch nor in the wiring pattern of 30 μm pitch. From such a tendency, it can be seen that even when a wiring pattern of narrower pitch is formed, a film carrier exhibiting more stable electrical properties can be produced by the use of the plating-pretreatment solution of the present invention.

What is claimed is:

1. A plating-pretreatment solution comprising an organic sulfonic acid, thiourea, fluoroboric acid and hypophosphorous acid.

2. The plating-pretreatment solution as claimed in claim 1, wherein the organic sulfonic acid is at least one compound selected from the group consisting of phenolsulfonic acid, methanesulfonic acid, ethanesulfonic acid, propanesulfonic acid, 2-propanesulfonic acid, butanesulfonic acid, 2-butanesulfonic acid, pentanesulfonic acid and chloropropanesulfonic acid.

3. The plating-pretreatment solution as claimed in claim 1, which comprises:
the organic sulfonic acid in an amount of 80 to 240 g/l,
thiourea in an amount of 80 to 240 g/l,
fluoroboric acid in an amount of 30 to 100 g/l, and
hypophosphorous acid in an amount of 30 to 100 g/l.

4. The plating-pretreatment solution as claimed in claim 1, which further comprises a surface active agent in an amount of not less than 10 g/l.

5. The plating-pretreatment solution as claimed in claim 1, which is a solution to remove metals remaining on an insulating film of a film carrier tape in which a wiring pattern is formed on a surface of the insulating film.

6. A plating-pretreatment method comprising contacting a film carrier tape in which a wiring pattern is formed on a surface of an insulating film with a plating-pretreatment solution comprising an organic sulfonic acid, thiourea, fluoroboric acid and hypophosphorous acid to remove metals remaining on the insulating film.

7. The plating-pretreatment method as claimed in claim 6, wherein the organic sulfonic acid is at least one compound selected from the group consisting of phenolsulfonic acid, methanesulfonic acid, ethanesulfonic acid, propanesulfonic acid, 2-propanesulfonic acid, butanesulfonic acid, 2-butanesulfonic acid, pentanesulfonic acid and chloropropanesulfonic acid.

8. The plating-pretreatment method as claimed in claim 6, wherein the plating-pretreatment solution comprises:
the organic sulfonic acid in an amount of 80 to 240 g/l,
thiourea in an amount of 80 to 240 g/l,
fluoroboric acid in an amount of 30 to 100 g/l, and
hypophosphorous acid in an amount of 30 to 100 g/l.

9. The plating-pretreatment method as claimed in claim 6, wherein the plating-pretreatment solution further comprises a surface active agent in an amount of not less than 10 g/l.

10. The plating-pretreatment method as claimed in claim 6, wherein the film carrier tape is contacted with the plating-pretreatment solution at a temperature of 30 to 80° C. for a period of 2 to 60 seconds.

11. The plating-pretreatment method as claimed in claim 6, wherein the film carrier tape to be treated with the plating-pretreatment solution is a film carrier tape formed from a base obtained by sputtering nickel and/or chromium on the insulating film surface without interposing an adhesive layer, then sputtering copper and further depositing copper.

12. The plating-pretreatment method as claimed in claim 6, which further comprises, after the treatment with the plating-pretreatment solution, a step of treating the film carrier tape with an acid treatment solution comprising 50 to 150 g/l of K₂S₂O₈, 5 to 20 ml/l of H₂SO₄ and 0 to 3 g/l of Cu at a temperature of 20 to 40° C. for a period of 5 to 20 seconds.
